(19) United States
(12) Patent Application Publication
(10) Pub. No.: US 2010/0045166 A1
(43) Pub. Date: Feb. 25, 2010

(54) ELECTRON EMITTING DEVICE AND LIGHT EMITTING DEVICE THEREWITH

(76) Inventors: So-Ra Lee, Suwon-si (KR); Jae-Myung Kim, Suwon-si (KR); Hee-Sung Moon, Suwon-si (KR); Yoon-Jin Kim, Suwon-si (KR); Kyu-Nam Joo, Suwon-si (KR); Hyun-Ki Park, Suwon-si (KR); Young-Suk Cho, Suwon-si (KR)

Correspondence Address: CHRISTIE, PARKER & HALE, LLP, PO BOX 7068, PASADENA, CA, 91109-7068, US

(21) Appl. No.: 12/538,007

(22) Filed: Aug. 7, 2009

(30) Foreign Application Priority Data
Aug. 22, 2008 (KR) 10-2008-0082365

(51) Int. Cl. H01J 63/04; H01J 21/10

(52) U.S. Cl. 313/496; 313/307

(57) ABSTRACT

An electron emitting device includes a substrate, a plurality of first wiring units, each of the plurality of first wiring units including a plurality of first electrodes extending in a first direction on the substrate and spaced apart from each other, a plurality of second wiring units, each of the plurality of second wiring units including a plurality of second electrodes each extending in a direction substantially opposite to the first direction and interposed between adjacent first electrodes of the plurality of first electrodes, and a plurality of first electron emitters at sides of the first electrodes and a plurality of second electron emitters at sides of the second electrodes, wherein at least one of the plurality of first wiring units or the plurality of second wiring units is configured to be driven separately.

### CROSS-REFERENCE TO RELATED PATENT APPLICATION

This application claims priority to and the benefit of Korean Patent Application No. 10-2008-0082365, filed on Aug. 22, 2008, in the Korean Intellectual Property Office, the disclosure of which is incorporated herein in its entirety by reference.

### BACKGROUND OF THE INVENTION

1. Field of the Invention

The present invention relates to an electron emitting device and a light emitting device including the electron emitting device.

2. Description of the Related Art

Light emitting devices include devices capable of emitting light that can be externally recognized. Light emitting devices include a front substrate on which an anode electrode and a fluorescent layer are formed, and a rear substrate on which an electron emission unit and a drive electrode are formed. The front substrate and the rear substrate are integrally coupled such that the edges of the front and rear substrates are attached to each other by a seal member. A vacuum is generated in an inner space between the front and rear substrates, such that the front and rear substrates and the seal member form a vacuum container.

The drive electrode includes a cathode electrode and a gate electrode positioned parallel to each other. The electron emission unit may be positioned at a side surface of the cathode electrode facing the gate electrode. The drive electrode and the electron emission unit form an electron emitting device.

In some light emitting devices, the anode electrode may be positioned at a surface of the fluorescent layer facing the rear substrate. The anode electrode increases brightness of a light emission surface by reflecting visible light emitted by the fluorescent layer toward the rear substrate. The anode electrode and the fluorescent layer form the light emission unit.

The light emitting device applies a predetermined drive voltage to the entire cathode electrode and the gate electrode. Also, a DC voltage (anode voltage) of more than several thousands volts is applied to the anode electrode to drive the light emitting device. An electric field is formed around the electron emission unit due to the difference in voltage between the cathode electrode and the gate electrode. Accordingly, electrons are emitted by the electron emission unit. The emitted electrons collide with a corresponding portion of the fluorescent layer by being attracted by the anode voltage so that the fluorescent layer emits light.

### SUMMARY OF THE INVENTION

In the above-described light emitting device, when a predetermined drive voltage is applied to the cathode electrode and the gate electrode to drive the light emitting device, light is concurrently emitted by the electron emitting devices arranged in a plurality of rows because the electron emitting devices are not individually turned on or off. Thus, a problem arises where scan driving is very difficult to execute in the above-described light emitting device.

Exemplary embodiments of the present invention provide an electron emitting device capable of bipolar driving and partial driving by individually driving at least one of the cathode electrodes or the gate electrodes, and a light emitting device including the electron emitting device.

According to an aspect of an exemplary embodiment of the present invention, there is provided an electron emitting device including a substrate, a plurality of first wiring units, each of the plurality of first wiring units including a plurality of first electrodes extending in a first direction on the substrate and spaced apart from each other, a plurality of second wiring units, each of the plurality of second wiring units including a plurality of second electrodes each extending in a direction substantially opposite to the first direction and interposed between adjacent first electrodes of the plurality of first electrodes, and a plurality of first electron emitters at sides of the first electrodes and a plurality of second electron emitters at sides of the second electrodes, wherein at least one of the plurality of first wiring units or the plurality of second wiring units is configured to be driven separately.

At least one of the plurality of first wiring units or the plurality of second wiring units may be configured to receive voltages separately.

A gap may be between the first electron emitters and the corresponding second electron emitters adjacent to the first electron emitters.

Each of the plurality of first wiring units and plurality of the second wiring units may be symmetrical alnog a direction substantially perpendicular to the first direction.

The first electron emitters may cover upper surfaces of the corresponding first electrodes and the second electron emitters may cover upper surfaces of the corresponding second electrodes.

The first electron emitters may be discontinuously formed along the sides of the first electrodes and the second electron emitters may be discontinuously formed along the sides of the second electrodes.

End portions of the plurality of first wiring units and end portions of the plurality of second wiring units may be on the same side of the substrate.

According to another aspect of an exemplary embodiment of the present invention, there is provided a light emitting device including a first substrate and a second substrate facing each other, a light emitting unit including an anode electrode on a surface of the first substrate and a fluorescent layer on a surface of the anode electrode facing the second substrate, and a plurality of electron emitting devices on a surface of the second substrate. Each of the electron emitting devices includes a plurality of first wiring units, each of the plurality of first wiring units including a plurality of first electrodes extending in a first direction and spaced apart from each other, a plurality of second wiring units, each of the plurality of second wiring units including a plurality of second electrodes each extending in a direction substantially opposite to the first direction and interposed between adjacent first electrodes of the plurality of first electrodes, and a plurality of first electron emitters at sides of the first electrodes and a plurality of second electron emitters at sides of the second electrodes, wherein at least one of the plurality of first wiring units or the plurality of second wiring units is configured to be driven separately.

The first electron emitters and the second electron emitters may be configured to emit electrons when voltages are applied to corresponding ones of the plurality of first wiring units and the plurality of second wiring units.

The electrons emitted by the first electron emitters and the second electron emitters may collide with the fluorescent layer to emit visible light.

A gap may be between the first electron emitters and the corresponding second electron emitters adjacent to the first electron emitters.

The plurality of first wiring units and the plurality of second wiring units may be symmetrical along a direction substantially perpendicular to the first direction.

The first electron emitters may cover upper surfaces of the corresponding first electrodes and the second electron emitters may cover upper surfaces of the corresponding second electrodes.

The first electron emitters may be discontinuously formed along the sides of the first electrodes and the second electron emitters may be discontinuously formed along the sides of the second electrodes.

End portions of the plurality of first wiring units and end portions of the plurality of second wiring units may be on the same side of the substrate.

### BRIEF DESCRIPTION OF THE DRAWINGS

The above and other features and aspects of the present invention will become more apparent by describing in detail exemplary embodiments thereof with reference to the attached drawings, of which:

FIG. 1 is a cross-sectional view of a portion of a light emitting device according to an embodiment of the present invention;

FIG. 2 is a plan view of a portion of an electron emitting unit according to an embodiment of the present invention;

FIG. 3 is an enlarged perspective view of a portion 11 of FIG. 2;

FIG. 4 is a plan view of a portion of an electron emitting unit according to another embodiment of the present invention;

FIG. 5 is a plan view of a portion of an electron emitting unit according to another embodiment of the present invention;

FIG. 6 is a plan view of a portion of an electron emitting unit according to another embodiment of the present invention;

FIG. 7 is a plan view of a portion of an electron emitting unit according to another embodiment of the present invention;

FIGS. 8A-8D are cross-sectional views illustrating a method of manufacturing an electron emitting unit according to an embodiment of the present invention; and

FIGS. 9A-9E are cross-sectional views illustrating a method of manufacturing an electron emitting unit according to another embodiment of the present invention.

### DETAILED DESCRIPTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concepts of the present invention to those skilled in the art. In the drawings, the thicknesses of layers and regions may be exaggerated for clarity.

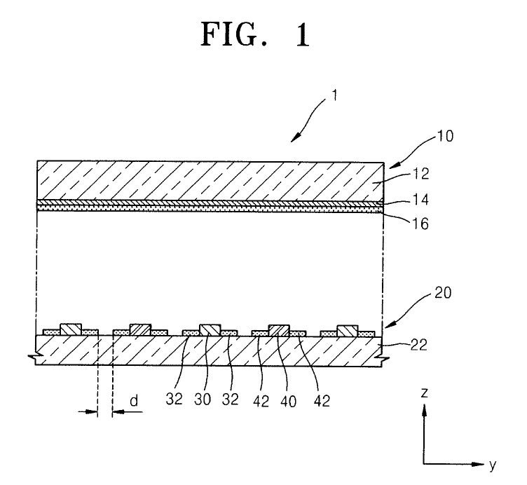

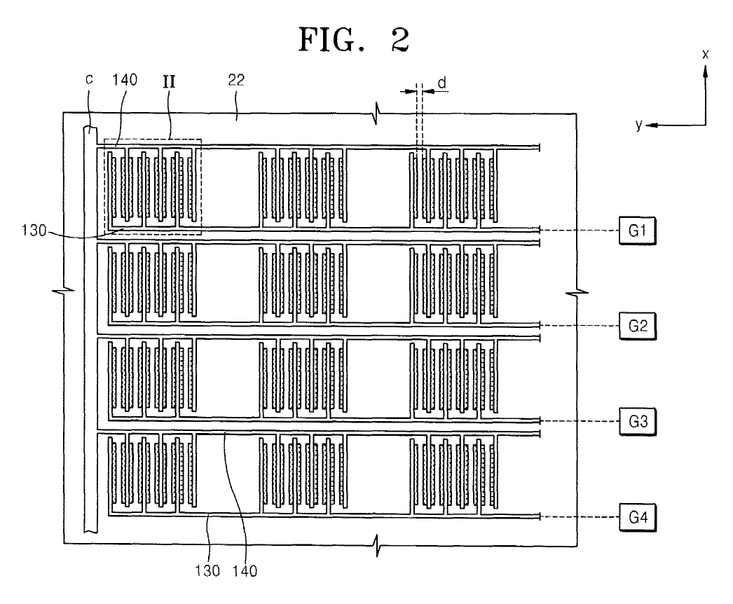

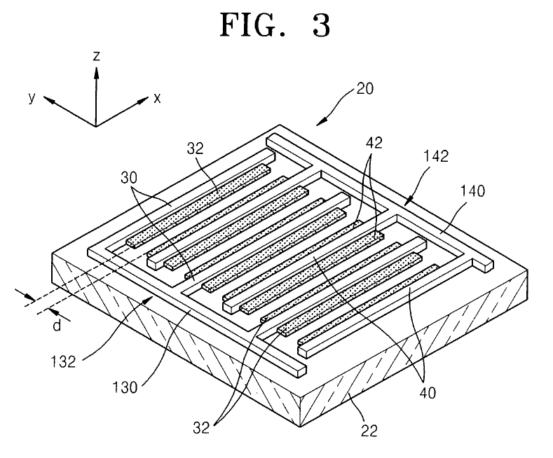

FIG. 1 is a cross-sectional view of a portion of a light emitting device according to an embodiment of the present invention. FIG. 2 is a plan view of a portion of an electron emitting unit according to an embodiment of the present invention. FIG. 3 is an enlarged perspective view of a portion 11 of FIG. 2.

Referring to FIGS. 1-3, a light emitting device 1 according to an embodiment of the present invention includes a first substrate 12 and a second substrate 22 facing each other and arranged parallel to each other with an inner space therebetween. A seal member (not shown) is arranged at the edges of the first and second substrates 12 and 22, so that the first and second substrates 12 and 22 are connected to each other. The inner space is made vacuous to approximately 10⁻⁶ torr so that the first substrate 12, the second substrate 22, and the seal member form a vacuum container.

The inner surface of each of the first substrate 12 and the second substrate 22, which is positioned inside the seal member, includes an effective area which contributes to the emission of visible light, and a non-effective area surrounding the effective area. An electron emitting device 20 for emitting electrons is provided in the effective area on the inner surface of the second substrate 22. A light emitting unit 10 for emitting a visible light is provided in the effective area on the inner surface of the first substrate 12.

The light emitting unit 10 is positioned on the first substrate 12 and, during the operation of the light emitting device 1, emits a visible light by receiving electrons from the electron emitting device 20 provided on the second substrate 22. The visible light passes through the first substrate 12 and is emitted out of the light emitting device 1.

In one embodiment, the electron emitting device 20 has a structure capable of bipolar driving. The light emitting unit 10 has a structure for improving brightness of a light emitting surface by maximizing an efficiency of reflection of a visible light.

In detail, referring to FIGS. 2 and 3, the electron emitting device 20 includes a plurality of first electrodes 30 extending in a first direction of the second substrate 22, that is, in a first direction along an X axis of FIG. 3 and arranged at intervals (e.g., at predetermined intervals), a plurality of second electrodes 40 positioned between the first electrodes 30 and extending in a direction opposite to the first direction, that is, a second direction along the X axis substantially parallel to the first direction in FIG. 3, a plurality of first electron emitting units 32 at both sides of each of the first electrodes 30 facing the second electrodes 40 and having a thickness smaller than that of each of the first electrodes 30, and a plurality of second electron emitting units 42 at both sides of each of the second electrodes 40 facing the first electrodes 30 and having a thickness smaller than that of each of the second electrodes 40. The first electrodes 30 and the second electrodes 40 may be arranged substantially parallel to each other.

A gap for preventing short-circuits is formed between each of the first electron emitting units 32 and each of the second electron emitting units 42, such that neighboring first and second electron emitting units 32 and 42 are positioned at an interval d from each other.

The first and second electron emitting units 32 and 42, as shown in FIGS. 1-3, may be formed in a line pattern in the lengthwise direction of the first electrodes 30 and second electrodes 40, respectively. Although it is not shown in the drawings, the first and second electron emitting units 32 and 42 may alternatively be formed, for example, in a plurality of discontinuous patterns in the lengthwise direction of the first and second electrodes 30 and 40.

Unlike the present embodiment, in an alternate embodiment in which the second substrate 22 is a front substrate and the first substrate 12 is a rear substrate and light is emitted through the second substrate 22, which may be transparent, when the first and second electron emitting units 32 and 42 are formed in a plurality of patterns that are discontinuous and separated from each other, the gap between each of the first electron emitting units 32 and each of the second electron emitting units 42 exposes the second substrate 22 so that a visible light transmission efficiency may be improved.

Referring to FIGS. 2 and 3, a first connection electrode 130 is provided at an end portion of each of the first electrode 30 to connect the end portions of the first electrodes 30. The first connection electrode 130 and the corresponding first electrodes 30 form a first wiring unit 132. A second connection electrode 140 is provided at an end portion of each of the second electrodes 40 to connect the end portions of the second electrodes 40. The second connection electrode 140 and the corresponding second electrodes 40 form a second wiring unit 142.

As shown in FIG. 3, the first electrodes 30 extend in a positive direction along the x axis. The first connection electrode 130 extends in a negative direction along the y axis substantially perpendicular to the first electrodes 30. The second electrodes 40 extend in a negative direction along the x axis. The second connection electrode 140 extends in a positive direction along the y axis.

The first and second electrodes 30 and 40 are formed on the electron emitting units 32 and 42 and have a higher height than the electron emitting units 32 and 42. To this end, the first and second electrodes 30 and 40 may be formed not only using a thin film process such as sputtering or a vacuum deposition method, but also a thick film process such as a screen printing method or a laminating method. Also, the first and second electrodes 30 and 40 may be formed in other various methods.

The electron emitting units 32 and 42 may include a material, for example, a carbon-based material and/or a nanometer sized material, that emits electrons when an electric field is applied in a vacuum state. The electron emitting units 32 and 42 may include a material selected from the group consisting of, for example, carbon, nanotube, graphite, graphite nanofiber, diamond, carbon having a diamond shape, silicon nanowire, and combinations thereof.

The electron emitting units 32 and 42 may include carbide-driven carbon. The carbide-driven carbon may be manufactured by thermochemically reacting a carbide chemical compounds with a gas including a halogen-group element, and extracting the non-carbon based elements from the chemical compound.

The carbide compound may be at least one of the carbide compounds selected from the group consisting of SiC4, B4C, TiC, Zt,Cx, Al4C3 CaC2, TixTayC, MoxWyC, TiNxCy, ZrxCy, and combinations thereof. The gas including a halogen group may be Cl2, TiCl4, and F2 gas. The electron emitting units 32 and 42 including the carbide-driven carbon exhibit very good uniform electrode emission and a long life span.

The electron emitting units 32 and 42 may be formed using, for example, a screen printing method. However, in the present invention, the method of forming the electron emitting unit is not limited to the screen printing method, and a variety of other methods may be used. A method of forming an electron emitting unit according to an embodiment of the present invention is described below.

Referring to FIGS. 2 and 3 together, a plurality of combined portions of the first electrodes 30, the second electrodes 40, the first wiring unit 132, the second wiring units 142, the first electron emitting unit 32, and the second electron emitting unit 42 are repeatedly arranged on the second substrate 22. In an embodiment of the present invention, each line of the combined portions (please refer to FIG. 3) is referred to as an “electron emitting unit line.”

End portions of the first wiring units 132 are connected to one of the first electrode drive units G1, G2, G3, or G4. Thus, the first wiring units 132 are separately driven, and in particular, a voltage is applied separately to the first wiring units 132 based on the corresponding first electrode drive unit G1, G2, G3, or G4. In doing so, the first electrodes 30 electrically connected to the first wiring units 132 are driven by separately applying a voltage to the first wiring units 132 connected to each of the first electrode drive units G1, G2, G3, and G4.

End portions of the second wiring units 142 are connected to a single second electrode drive unit C. The second electrode drive unit C may be a cathode electrode drive unit by itself or a wiring connecting the cathode electrode drive unit. As a selective embodiment, although it is not illustrated, each of the second wiring units 142 may be separately connected to the second electrode drive unit C to be separately driven.

In the present embodiment, the electron emitting device 20 has a structure capable of scan driving, that is, partial driving of the electron emitting device. In the electron emitting device 20 of FIGS. 2 and 3, a voltage is applied to the second electrode drive unit C, and accordingly the voltage is applied to the second wiring units 142.

A voltage is separately applied to the first wiring units 132 connected to each of the first electrode drive units G1, G2, G3, and G4 so that a voltage is applied to the first electrodes 30. For example, referring to FIG. 2, when only G1 is turned on and G2, G3, and G4 are turned off and a voltage (e.g., a predetermined voltage) is applied to the second electrode drive unit C, electrode emission is performed only in the first electron emitting unit line of FIG. 2 and no electron emission is generated in the second to fourth electron emitting unit lines.

As the first electrode drive units G1, G2, G3, and G4, respectively apply voltage to the corresponding first wiring units 132 connected thereto, the electron emitting unit lines may be selectively driven so that scan driving may be performed.

Referring back to FIG. 1, the light emitting unit 10 includes an anode electrode 14, for example, a metal reflection film, formed on an inner surface, that is, a lower surface, of the first substrate 12, and a fluorescent layer 16 formed on a surface of the anode electrode 14 facing the second substrate 22.

The fluorescent layer 16 may include a mixed fluorescent material that is a mixture of a red fluorescent material, a green fluorescent material, and a blue fluorescent material, and emits a white light. The fluorescent layer 16 may be positioned in the effective area of the first substrate 12. The anode electrode 14 may receive an anode voltage from a power unit outside the vacuum container.

The anode electrode 14 may be formed of a transparent conductive material, such as indium tin oxide (ITO), to transmit a visible light emitted from the fluorescent layer 16. The anode electrode 14 may also be formed of aluminum having a slight thickness of several thousands angstroms and have a plurality of fine holes for passing an electron beam. A plurality of spacers (not shown) are arranged between the first and second substrates 12 and 22 to support a compression force applied to the vacuum container and to maintain a substantially constant interval between the first and second substrates 12 and 22.

In the above-described light emitting device 1, light is generated for each electron emitting unit line. The light emitting device 1 applies a scan drive voltage to the second wiring unit 142, a data drive voltage to the first wiring units 132 of one or more of the electron emitting unit lines, and a DC voltage (anode voltage) of an amount of approximately 10 kV or more to the anode electrode 14.

Then, an electric field is formed in the vicinity of the electron emitting units 32 and 42 at the electron emitting unit line in which the voltage difference between the first and second electrodes 30 and 40 is over a threshold value, that is, at the second electrodes 40 and the first electrodes 30 of the electron emitting unit lines to which the drive voltage is applied, so that electrons may be emitted therefrom. The electrons emitted from the electron emitting units 32 and 42 are attracted by the anode voltage applied to the anode electrode 14 and collide with the fluorescent layer 16 to generate light. The visible light emitted from the fluorescent layer 16 passes through the first substrates 12.

The light emitting device 1 of an embodiment of the present invention may employ a drive method of alternately and repeatedly inputting a scan drive voltage and a data drive voltage to the first and second electrodes 30 and 40, respectively. An electrode to which a lower voltage between the scan drive voltage and the data drive voltage is applied may be considered a cathode electrode, while an electrode receiving a higher voltage may be considered a gate electrode.

The electron emitting device 20 of the present embodiment characteristically applies a separate voltage to the first wiring unit of the electron emitting unit lines for scan driving. In detail, as a voltage is applied to the second electrode drive unit C, the voltage is applied to the second wiring units 142 of all of the electron emitting unit lines connected to the second electrode drive unit C while a voltage is separately applied to the first electrode drive units G1, G2, G3, G4, . . . that is, a drive voltage is applied only to the first wiring units 132 of one or more selected electron emitting unit lines connected to the first electrode drive unit.

In this case, electrons are emitted from the electron emitting unit based on the voltage difference between the first electrodes 30 connected to the first wiring units 132 and the second electrodes 40 connected to the second wiring units 142. The emitted electrons are attracted by the anode voltage and collide with the corresponding portion of the fluorescent layer 16.

In contrast, since electrons are not emitted from the electron emitters of the electron emitting unit lines in which a voltage is not applied to the first wiring unit 132, or where the voltage difference between the first and second electrodes 30 and 40 is not over a threshold value, the portions of the fluorescent layer corresponding to the electron emitting unit lines to which the voltage is not applied does not generate light. Thus, the light emitting portion may be controlled by controlling whether a sufficient or appropriate voltage is applied to one or more of the first electrode drive units G1, G2, G3, or G4.

The electron emitting units 32 and 42 may be formed to a thickness smaller than the first electrodes 30 and the second electrodes 40. The first electrodes 30 and the first electrons emitting units 32 may have a thickness difference of about 1-10 μm. The second electrodes 40 and the second electron emitting units 42 may also have a thickness difference of about 1-10 μm. When a difference in the thickness between the electrode unit and the electron emitting unit is less than 1 μm, high voltage stability may be deteriorated and high brightness, high efficiency, and high life span may be difficult to achieve due to the deterioration of a shielding effect of the anode electric field. When a difference in the thickness between the electrode unit and the electron emitting unit is greater than 10 μm, the distance between the electrode unit and the electron emitting unit increases such that the drive voltage increases, which may not be preferable.

In the above structure, the first electrodes 30 and the second electrodes 40, having a height higher than a height of the electrode emitting units 32 and 42, change an electric field distribution around the electron emitting units 32 and 42, such that the effect of the anode electric field to the electron emitting units 32 and 42 is decreased. When an anode voltage of 10 kV or more is applied to the anode electrode 14 to improve brightness of the light emitting surface, the first and second electrodes 30 and 40 may weaken the anode electric field around the electron emitting units 32 and 42 so that diode emission by the anode electric field may be effectively reduced.

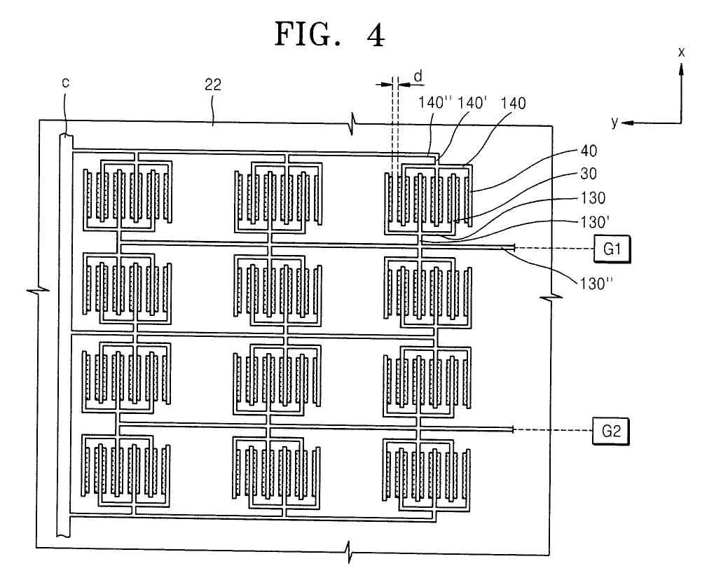

FIG. 4 is a plan view of a portion of an electron emitting unit according to another embodiment of the present invention, which is similar to the embodiment of FIG. 2. The same reference numerals of constituent elements of FIGS. 1-3 are used for those of FIG. 4. In FIG. 4, reference numeral 130 indicates a first connection electrode, reference numeral 130′ indicates a first collection electrode vertically extending from the first connection electrode 130, and reference numeral 130″ indicates a first coupling electrode connected to the first collection electrode 130′ and extending to the first electrode drive units G1, G2, . . . . The first connection electrode 130, the first collection electrode 130′, and the first coupling electrode 130″ form a first wiring unit.

In FIG. 4, reference numeral 140 indicates a second connection electrode, reference numeral 140′ indicates a second collection electrode vertically extending from the second connection electrode 140, and reference numeral 140″ indicates a second coupling electrode connected to the second collection electrode 140′ and extending to the second electrode drive unit C. The second connection electrode 140, the second collection electrode 140′, and the second coupling electrode 140″ form a second wiring unit.

Referring to FIG. 4, the first wiring unit and the second wiring unit extend in a lengthwise direction (y direction) and are symmetric with respect to the lengthwise direction. Thus, two electron emitting unit lines are formed with respect to each of the first electrode drive units G1, G2, . . . . Therefore, in FIG. 4, when an individual drive voltage is applied to one of the first electrode drive units, for example, G1, two light emitting unit lines are driven.

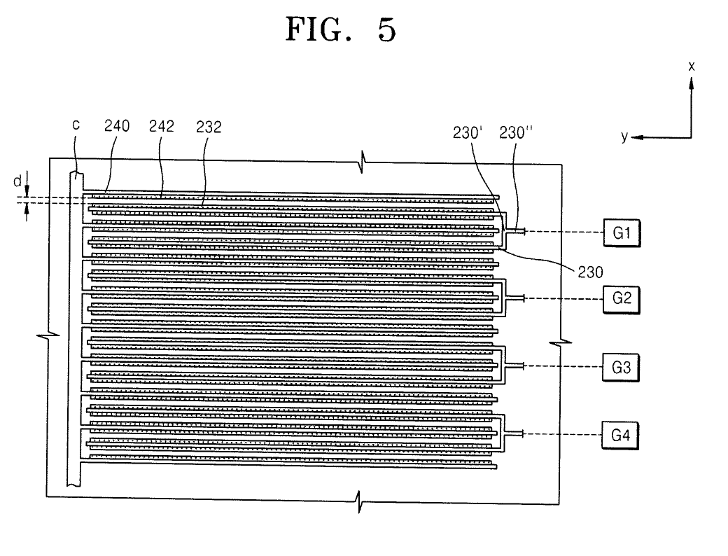

FIG. 5 is a plan view of a portion of an electron emitting unit according to another embodiment of the present invention, which is similar to the embodiment of FIG. 2. In FIG. 5, a plurality of second electrodes 240 extend substantially perpendicularly from the second electrode drive unit C (e.g., in a negative y direction). A plurality of first electrodes 230 extend substantially perpendicularly from a first collection electrode 230′ (e.g., in a positive y direction) between the second electrodes 240. A first coupling electrode 230″ extends from the first collection electrode 230′ to a corresponding one of the first electrode drive units G1, G2, G3, G4, . . . .

First electron emitting units 232 and second electron emitting units 242 are positioned at side surfaces of the first electrodes 230 and the second electrodes 240. An interval d is formed between adjacent first and second electron emitting units 232 and 242.

As shown in FIG. 5, the first electrode drive units G1, G2, G3, G4, . . . are respectively connected to the first coupling electrodes 230″, such that a drive voltage may be separately applied to each of the first coupling electrodes 230″. Since the application of the separate drive voltages of the electron emitting device of FIG. 5 and general light emitting principles according thereto are similar to FIG. 4, a description thereof will be omitted herein.

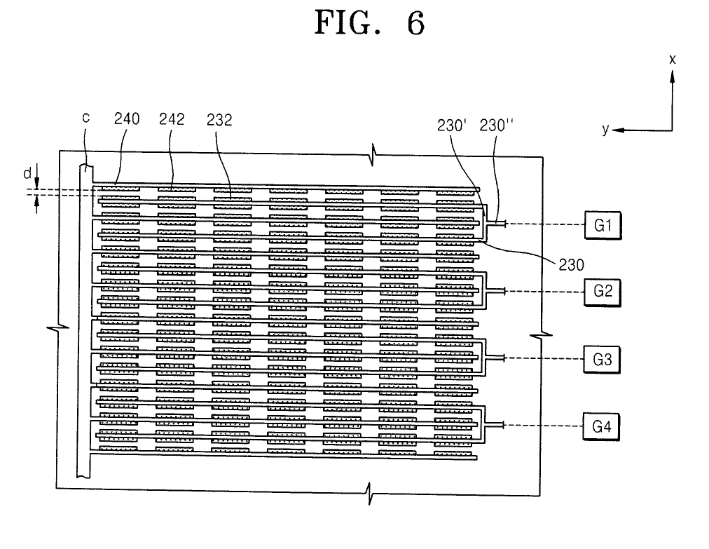

FIG. 6 is a plan view of a portion of an electron emitting unit according to another embodiment of the present invention, which is similar to the embodiment of FIG. 5. FIG. 6 is different from FIG. 5 in that the first electron emitting units 232 and the second electron emitting units 242 are discontinuously formed along the side surfaces of the first and second electrodes 230 and 240, respectively.

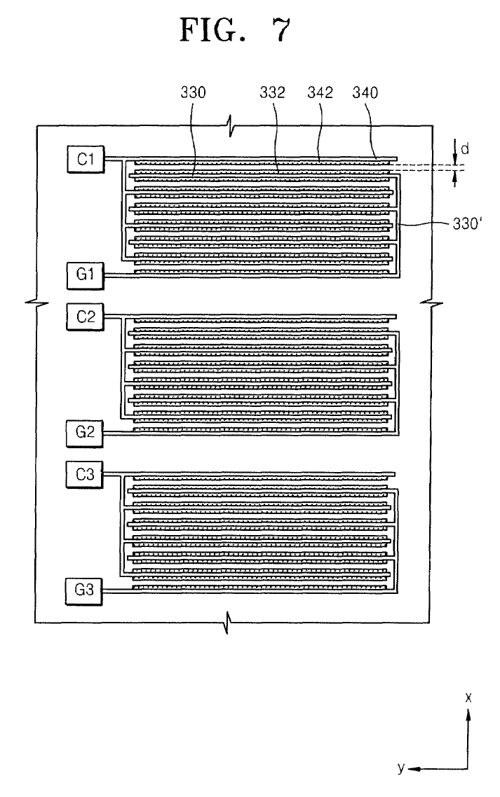

FIG. 7 is a plan view of a portion of an electron emitting unit according to another embodiment of the present invention. Referring to FIG. 7, the first electrode drive units G1, G2, G3, . . . and second electrode drive units C1, C2, C3, . . . are arranged on the same side on a substrate. That is, the first electrode drive units G1, G2, G3, . . . and the second electrode drive units C1, C2, C3, . . . are arranged on one side with respect to a center arrangement portion including a first electron emitting unit 332 and a second electron emitting unit 342, rather than on both sides with respect to the center arrangement portion.

In the case of FIG. 7, since the first electrode drive units G1, G2, G3, . . . and the second electrode drive units C1, C2, C3, . . . are respectively provided, a voltage may be separately applied to each electrode drive unit.

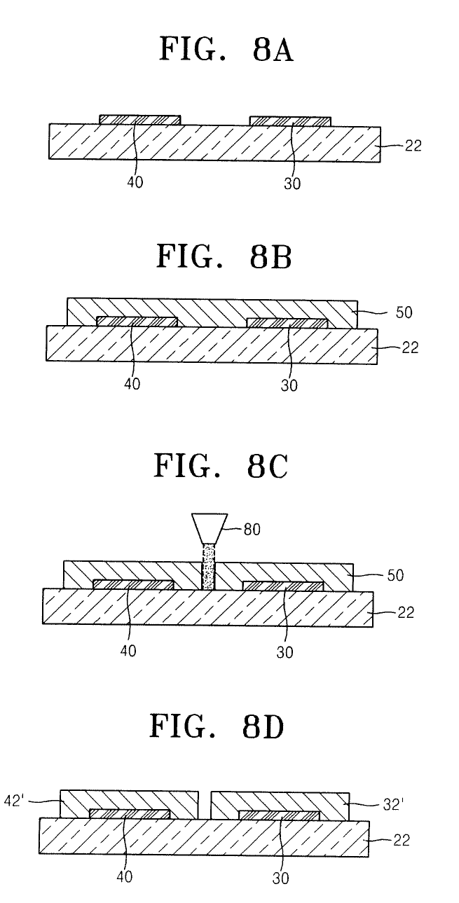

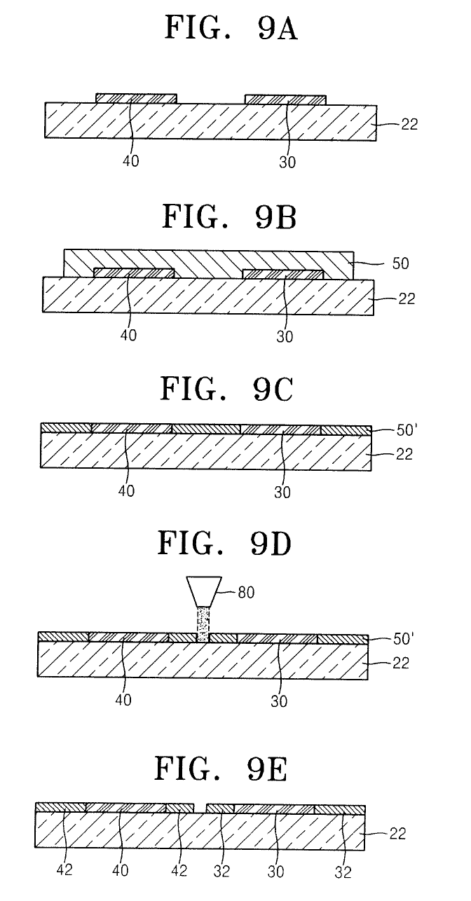

FIGS. 8A-8D are cross-sectional views illustrating a method of manufacturing an electron emitting unit according to an embodiment of the present invention. FIGS. 9A-9E are cross-sectional views illustrating a method of manufacturing an electron emitting unit according to another embodiment of the present invention.

Referring to FIG. 8A, a first electrode 30 and a second electrode 40 are formed at positions (e.g., at predetermined positions) on a second substrate 22. In FIG. 8B, the first electrode 30 and the second electrode 40 are embedded in an electron emitting material 50. In FIG. 8C, the electron emitting material 50 between the first electrode 30 and the second electrode 40 is ablated using a laser generation apparatus 80. In FIG. 8D, a gap is formed between a first electron emitting unit 32′ with embedded first electrode 30 and a second electron emitting unit 42′ with embedded second electrode 40. The first electron emitting units 32′ may respectively cover upper surfaces of the first electrodes 30 and the second electron emitting units 42′ may respectively cover upper surfaces of the second electrodes 40.

As the gap is formed using a laser in one embodiment, a distance may be formed accurately and finely. The method shown in FIGS. 8A-8D may be applied to a case in which the electron emitting material may not be a photosensitive material.

FIG. 9A-9E illustrates a method of manufacturing an electron emitting unit according to another embodiment of the present invention in which the electron emitting material may not be a photosensitive material. Referring to FIG. 9A, the first and second electrodes 30 and 40 are formed on the second substrate 22 in a shape (e.g., a predetermined shape). In FIG. 9B, the first and second electrodes 30 and 40 are embedded in a photosensitive electron emitting material.

Next, in FIG. 9C, light is emitted onto a rear surface of the substrate 22 to expose and develop the substrate 22. Thus, the electron emitting material formed in portions corresponding to the first and second electrodes 30 and 40 may be removed, such that an electron emitting material 50′ is left between the first and second electrodes 30 and 40. In FIG. 9D, similarly as shown in FIG. 8C, part of the electron emitting material 50′ between the first and second electrodes 30 and 40 is ablated using the laser generation apparatus 80. As a result, a gap is formed between adjacent first and second electron emitting units 32 and 42.

As described above, in the electron emitting device capable of scan driving and the light emitting device including the electron emitting device in accordance with exemplary embodiments of the present invention, the light emitting device may be partially driven. Also, since the electron emitting units face each other, bipolar driving may be performed, such that the life span and brightness of the electron emitting units may be improved. Furthermore, larger light emitting units may be be provided.

While the present invention has been particularly shown and described with reference to exemplary embodiments thereof, it will be understood by those of ordinary skill in the art that various changes in form and details may be made herein without departing from the spirit and scope of the present invention as defined by the following claims and equivalents thereof.

What is claimed is:

1. An electron emitting device comprising:
a substrate;
a plurality of first wiring units, each of the plurality of first wiring units comprising a plurality of first electrodes extending in a first direction on the substrate and spaced apart from each other;
a plurality of second wiring units, each of the plurality of second wiring units comprising a plurality of second electrodes each extending in a direction substantially opposite to the first direction and interposed between adjacent first electrodes of the plurality of first electrodes; and
a plurality of first electron emitters at sides of the first electrodes and a plurality of second electron emitters at sides of the second electrodes,
wherein at least one of the plurality of first wiring units or the plurality of second wiring units is configured to be driven separately.

2. The electron emitting device of claim 1, wherein at least one of the plurality of first wiring units or the plurality of second wiring units is configured to receive voltages separately.

3. The electron emitting device of claim 1, wherein a gap is between the first electron emitters and the corresponding second electron emitters adjacent to the first electron emitters.

4. The electron emitting device of claim 1, wherein each of the plurality of first wiring units and the plurality of second wiring units is symmetrical along a direction substantially perpendicular to the first direction.

5. The electron emitting device of claim 1, wherein the first electron emitters cover upper surfaces of the corresponding first electrodes and the second electron emitters cover upper surfaces of the corresponding second electrodes.

6. The electron emitting device of claim 1, wherein the first electron emitters are discontinuously formed along the sides of the first electrodes and the second electron emitters are discontinuously formed along the sides of the second electrodes.

7. The electron emitting device of claim 1, wherein end portions of the plurality of first wiring units and end portions of the plurality of second wiring units are on the same side of the substrate.

8. A light emitting device comprising:
a first substrate and a second substrate facing each other;
a light emitting unit comprising an anode electrode on a surface of the first substrate and a fluorescent layer on a surface of the anode electrode facing the second substrate; and
a plurality of electron emitting devices on a surface of the second substrate,
wherein each of the electron emitting devices comprises:
a plurality of first wiring units, each of the plurality of first wiring units comprising a plurality of first electrodes extending in a first direction and spaced apart from each other;
a plurality of second wiring units, each of the plurality of second wiring units comprising a plurality of second electrodes each extending in a direction substantially opposite to the first direction and interposed between adjacent first electrodes of the plurality of first electrodes; and
a plurality of first electron emitters at sides of the first electrodes and a plurality of second electron emitters at sides of the second electrodes,
wherein at least one of the plurality of first wiring units or the plurality of second wiring units is configured to be driven separately.

9. The light emitting device of claim 8, wherein the first electron emitters and the second electron emitters are configured to emit electrons when voltages are applied to corresponding ones of the plurality of first wiring units and the plurality of second wiring units.

10. The light emitting device of claim 9, wherein the electrons emitted by the first electron emitters and the second electron emitters collide with the fluorescent layer to emit visible light.

11. The light emitting device of claim 9, wherein the first electron emitters and the second electron emitters are configured to emit electrons when a voltage difference between the voltage applied to the corresponding first wiring unit and the voltage applied to the corresponding second wiring unit is greater than a threshold voltage.

12. The light emitting device of claim 8, wherein a gap is between the first electron emitters and the corresponding second electron emitters adjacent to the first electron emitters.

13. The light emitting device of claim 8, wherein the plurality of first wiring units and the plurality of second wiring units are symmetrical along a direction substantially perpendicular to the first direction.

14. The light emitting device of claim 8, wherein the first electron emitters cover upper surfaces of the corresponding first electrodes and the second electron emitters cover upper surfaces of the corresponding second electrodes.

15. The light emitting device of claim 8, wherein the first electron emitters are discontinuously formed along the sides of the first electrodes and the second electron emitters are discontinuously formed along the sides of the second electrodes.

16. The light emitting device of claim 8, wherein end portions of the plurality of first wiring units and end portions of the plurality of second wiring units are on the same side of the substrate.
